(19) United States
(12) Patent Application Publication
(10) Pub. No.: US 2012/0164863 A1
(43) Pub. Date: Jun. 28, 2012

(54) CARD EDGE CONNECTOR

(75) Inventor: Daw Wei Lee, Singapore (SG)

(73) Assignee: Molex Incorporated, Lisle, IL (US)

(21) Appl. No.: 13/333,122

(22) Filed: Dec. 21, 2011

(30) Foreign Application Priority Data
Dec. 22, 2010 (SG) 201009497-7

(51) Int. Cl. H01R 13/15

(52) U.S. Cl. 439/260

(57) ABSTRACT

A card edge connector comprises an insulating body and a plurality of terminals. The insulating body comprises a base defining a forward mating slot and a plurality of passageways communicating with the mating slot, and two flexible arms respectively extending forward and upward from two ends of the base. Each flexible arm is provided with a locking member, a pressing member near the locking member, and a stopping member near the locking member and lower than the pressing member. The plurality of terminals are correspondingly fixed in the plurality of passageways. Each terminal includes a fixing portion positioned in the base, a soldering portion extending out from the base, and a contact portion extending into the mating slot.

### RELATED APPLICATIONS

This application claims priority to Singapore Application No. 201009497-7, filed Dec. 22, 2010, which is incorporated herein by reference in its entirety.

### FIELD OF THE INVENTION

The present invention relates to a card edge connector, and more particularly, to an inclined-design card edge connector.

### DESCRIPTION OF THE RELATED ART

As electronic and information technology develops, more and more consumers use compact electronic devices, and there is a huge need for a card edge connector that is small in size so as to follow market trends and meet consumer demand.

As shown in FIG. 1, Taiwan Patent Publication No. 183547 discloses an inclined-design card edge connector 7 that occupies less space on a PCB (not shown), allowing the addition of more electrical elements. The card edge connector 7 comprises a body 70, a plurality of terminals 71, and two latches 72. The body 70 includes a receiving portion 700 for receiving a daughter board (not shown), and the plurality of terminals 71 are arranged within the receiving portion 700 to electrically connect the daughter board to a mother board (not shown). The body 70 further comprises two assistant latches 701 near each end of the receiving portion 700, two resistance portions 702 at two ends, and two leading posts 703 in the bottom to be inserted into the mother board. The latches 72 are respectively defined on two sides of the receiving portion 700. Each latch 72 further comprises a spring portion 720 and a locking portion 721 extending toward the receiving portion 700 from the spring portion 720. The spring portion 720 extends farther than the corresponding resistance portion 702 to form an extending portion 722, on the top of which a handle 723 is provided.

After being inserted into the card edge connector 7, the daughter board is rotated from an inserted position to a locked position and the spring portions 720 can correspondingly deform to allow the daughter board to be positioned in the receiving portion 700. The assistant latches 701 resist the daughter board to prevent it from being over-rotated. In the locked position, the locking portion 721 locks the daughter board in place. To release the daughter board, the handles 723 are pulled outward, and accordingly the spring portion 720 deforms to release the daughter board from the receiving portion 700. The resisting portions 702 will resist the spring portion 720 to prevent it from over-deforming.

However, the two assistant latches 701 provided near each end of the receiving portion 700 increase the length of the body 70, and accordingly increases the length of the entire card edge connector 7. That is, the inclined-design card edge connector 7 is still difficult to use in compact electrical devices. Thus, certain individuals would appreciate further reductions in size to existing card edge connector designs.

### SUMMARY OF THE INVENTION

A card edge connector comprises an insulating body and a plurality of terminals. The insulating body comprises a base defining a forward mating slot and a plurality of passageways communicating with the mating slot, and two flexible arms extending forward and upward from two ends of the base. Each flexible arm is provided with a locking member, a pressing member near to locking member, and a stopping member near the locking member and lower than the pressing member. The plurality of terminals are correspondingly fixed in the plurality of passageways. Each terminal includes a fixing portion positioned on the base, a soldering portion extending out of the base, and a contact portion extending into the mating slot.

In another embodiment, the stopping member and the locking member connect with each other, and the pressing member and the locking member connect with each other. The card edge connector further comprises two positioning posts extending from the bottom of the insulating body. Two securing members are positioned near the corresponding positioning posts, and each securing member comprises a fixing slice and a soldering slice connected with the fixing slice. The insulating body correspondingly defines a fixing slot for securing the securing member at the bottom of each side, and the soldering slice extends out from the insulating body. An assistant base further extends from each of the two sides of the base, and a resistance member further extends from the assistant base to be near the outside of the corresponding flexible arm. When an electronic card is inserted into the card edge connector; the locking members are contained in notches on two sides of the electronic card, the pressing members press an upper surface of the electronic card, and the stopping members support a lower surface of the electronic card. The plurality of terminals comprise a group of upper terminals and a group of lower terminals, and accordingly, the plurality of passageways comprise a group of upper passageways for receiving the group of upper terminals and a group of lower passageways for receiving the group of lower terminals.

### BRIEF DESCRIPTION OF THE DRAWINGS

The disclosure provides various advantages and novel features will become more apparent when taken in conjunction with the accompanying drawings in which:

FIG. 1 is a perspective view showing a conventional card edge connector;

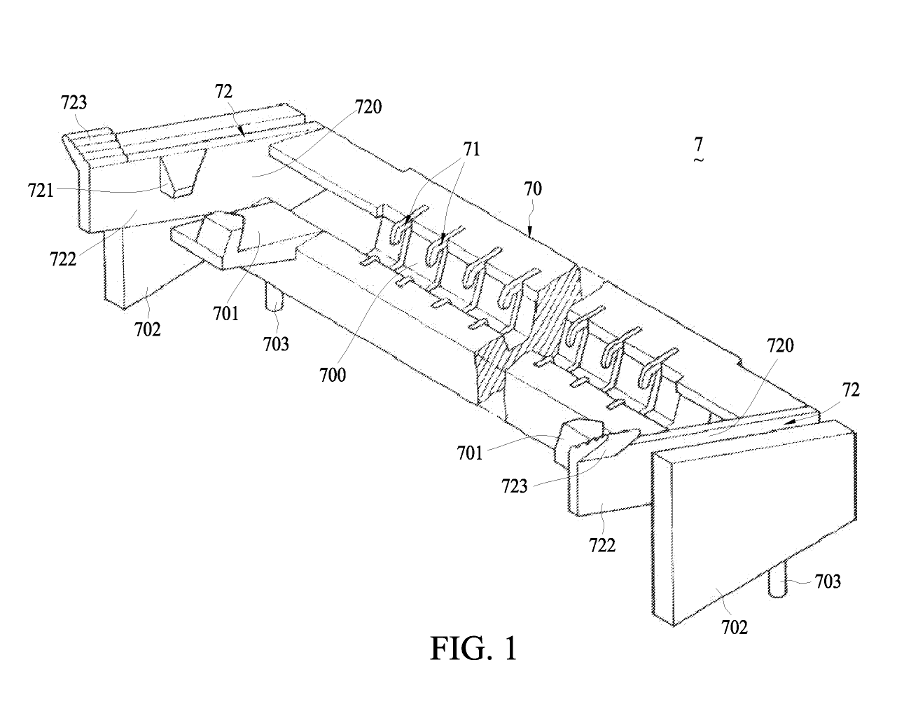

FIG. 2 is a perspective view showing a card edge connector mounted on a PCB, locking an inserted electronic card;

FIG. 3 is a perspective view showing a card edge connector mounted on a PCB, locking an inserted electronic card;

FIG. 4 is a perspective view showing a card edge connector mounted on a PCB;

FIG. 5 is a perspective view showing a card edge connector mounted on a PCB;

FIG. 6 is a perspective view showing a card edge connector;

FIG. 7 is an exploded perspective view corresponding to FIG. 2;

FIG. 8 is an exploded perspective view corresponding to FIG. 3;

FIG. 9 is a side view of a card edge connector mounted on a PCB locking an inserted electronic card;

FIG. 10 shows a card edge connector mounted on a PCB locking an inserted electronic card in front view; and

FIG. 11 shows a card edge connector mounted on a PCB locking an inserted electronic card in back view.

### DETAILED DESCRIPTION OF THE INVENTION

Hereinafter, embodiments of the present invention are described in detail with reference to the attached drawings.

One benefit of disclosure is the ability to provide an improved inclined-design card edge connector that is small in size in which an inserted card can be secured. The disclosure describes a card edge connector providing locking members, pressing members, and stopping members on the flexible arms to reduce the length of the insulating body. The pressing members and stopping members hold the inserted electronic card to minimize any excessive movement when a card is locked in place or during mechanical shock and vibration. Thus, the design provides an advantage in providing a more secure electrical connection and a reduced size.

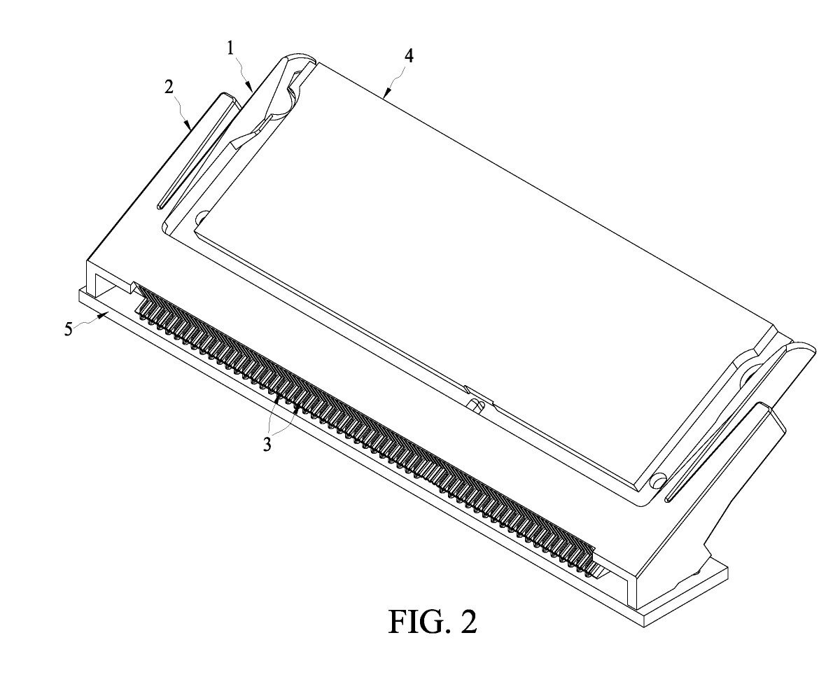

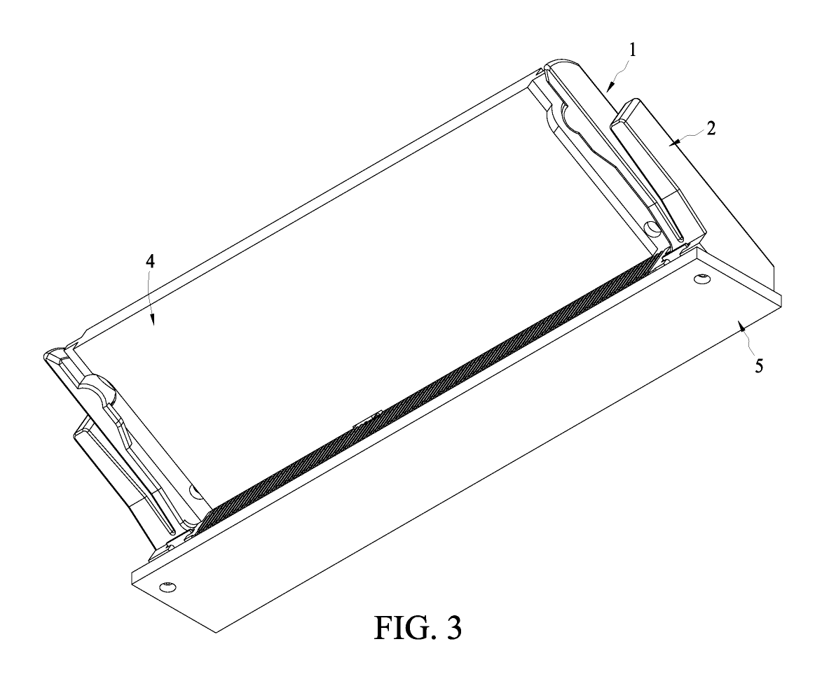

As illustrated in FIGS. 2 and 3, an inclined-design card edge connector 1 according to an embodiment comprises an insulating body 2 and a plurality of terminals 3 positioned in the insulating body 2 for electrically connecting an inserted electronic card 4 to a PCB 5 in a locked position.

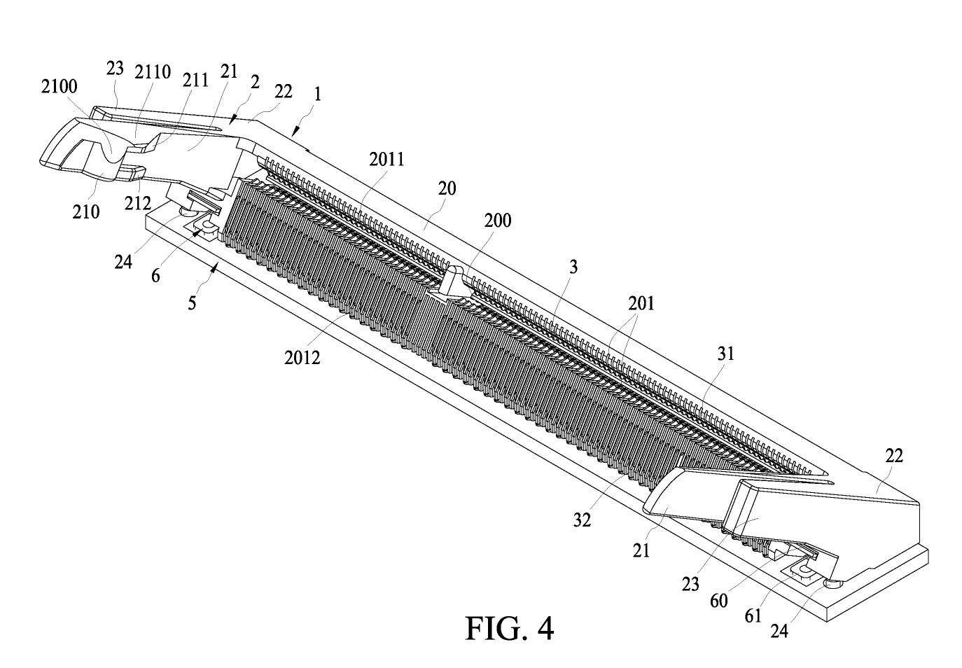

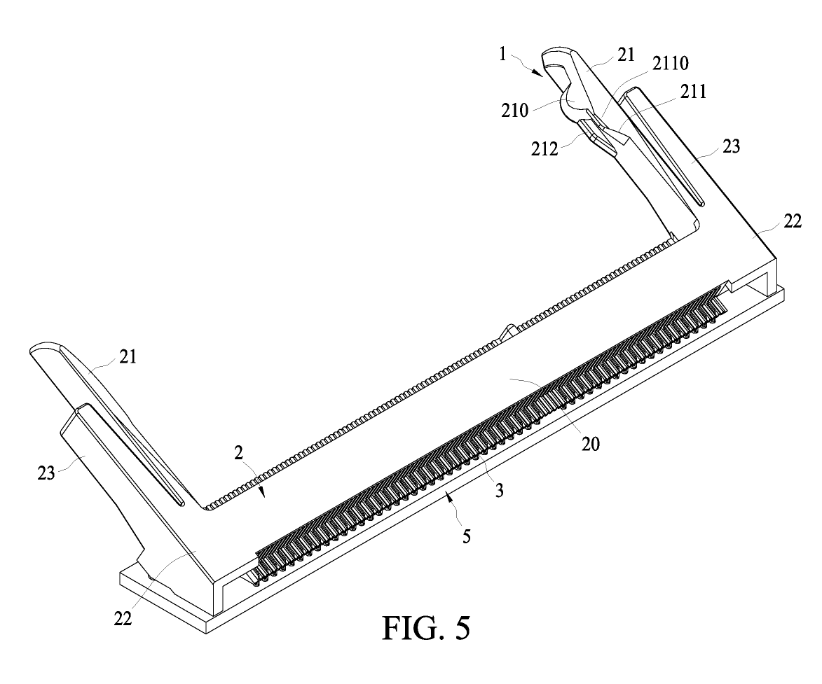

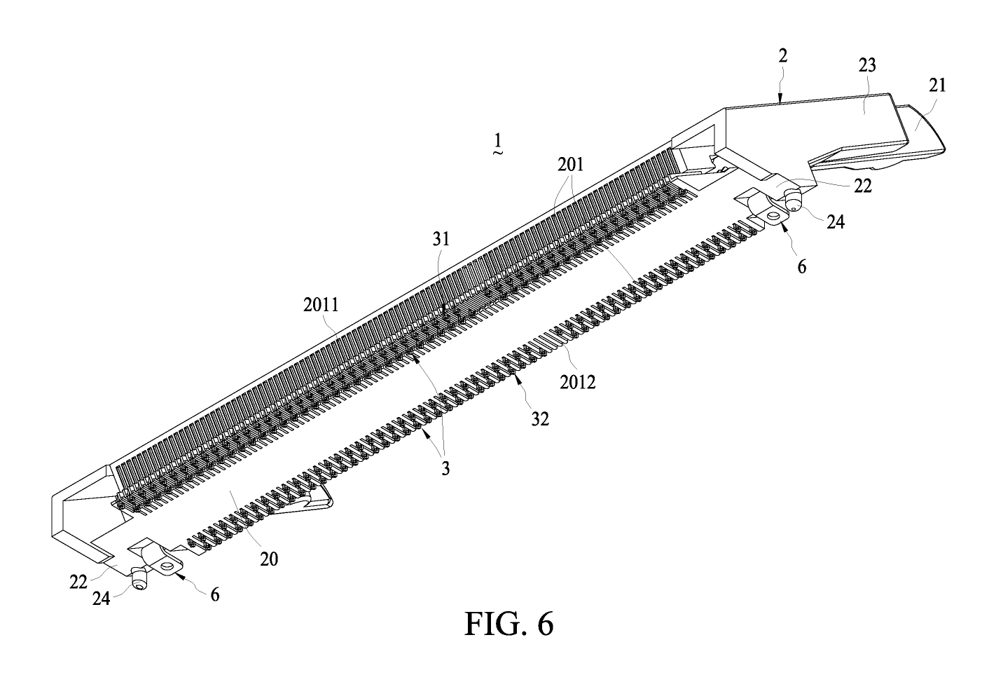

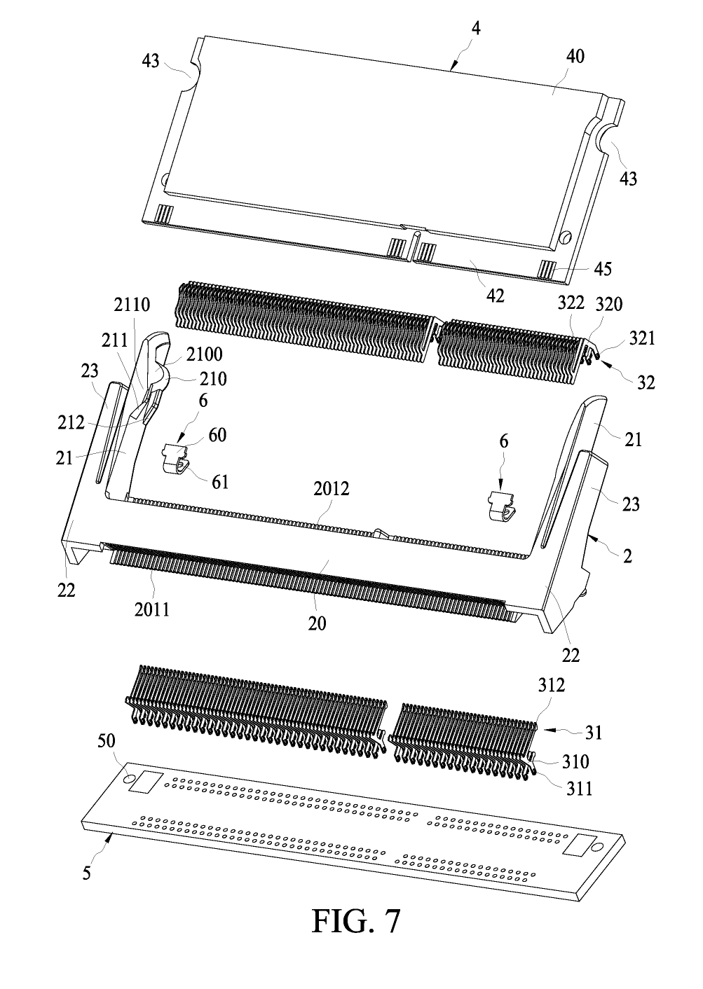

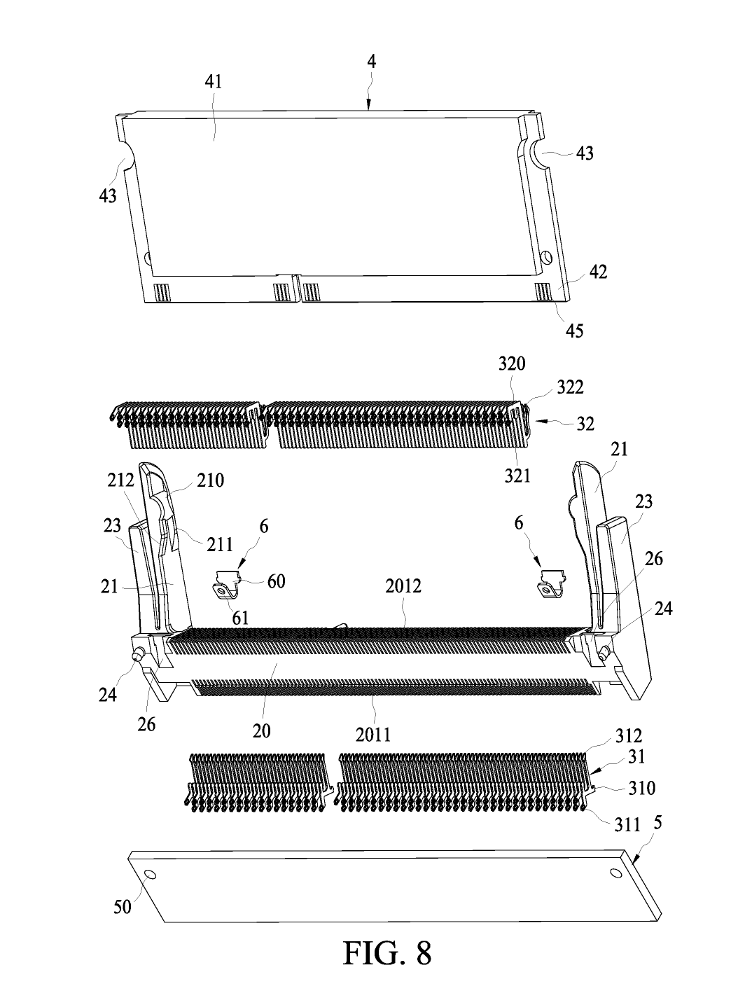

As shown in FIGS. 4 to 8, the insulating body 2 includes an elongated base 20 and two flexible arms 21 inclined extending from the base 20. The base 20 defines a forward mating slot 200 where the electronic card 4 can be inserted and locked; and a plurality of passageways 201 communicating with the mating slot 200. The plurality of passageways 201 are arranged in two groups, that is, a group of upper passageways 2011 and a group of lower passageways 2012. The two flexible arms 21 are inclined to the base 20 in a vertical plane, that is, respectively extending forward and upward from two ends of the base 20. Each flexible arm 21 is provided with a locking member 210 near the front end, a pressing member 211 near the locking member 210, and a stopping member 212 near the locking member 210 and lower than the pressing member 211. The upper surface 2110 of the locking member 210 and the upper surface 2110 of the pressing member 211 are shaped into leading surfaces to facilitate the inserted electronic card 4 going beyond the locking member 210 and the pressing member 211 during rotation of the electronic card 4 from an inserted position to the locked position. In the preferred embodiment, the locking member 210 and the stopping member 212 connect with each other to strengthen the stopping member 212, and the locking member 210 and the pressing member 211 connect with each other to strengthen the pressing member 211. In other embodiments, the locking member 210 may only connect with the pressing member 211 or the stopping member 212, or connects with neither the pressing member 211 nor the stopping member 212. In addition, an assistant base 22 continuously extends from each end of the base 20, and a resistance member 23 further extends inclined and forward from the assistant base 22 to be near the outside of the corresponding flexible arm 21. The insulating body 2 further defines positioning posts 24 on the bottom of the assistant base 22 to be inserted into corresponding positioning holes 50 provided on the PCB 5 to mount the card edge connector 1 on the PCB 5. In other embodiments, the positioning posts 24 are provided on the bottom of the base 20.

The plurality of terminals 3 are fixed in the plurality of passageways 201. Corresponding to the group of upper passageways 2011 and the group of lower passageways 2012, the plurality of terminals 3 are arranged into a group of upper terminals 31 positioned in the corresponding upper passageways 2011 and a group of lower terminals 32 positioned in the corresponding lower passageways 2012. Each upper terminal 31 includes a fixing portion 310 positioned in the base 20, a soldering portion 311 extending out of the base 20, and a contact portion 312 extending into the mating slot 200. Each lower terminal 32 includes a fixing portion 320 positioned in the base 20, a soldering portion 321 extending out of the base 20, and a contact portion 322 extending into the mating slot 200. Corresponding to the soldering portions 311, 321, the PCB 5 defines a plurality of soldering holes 54 for receiving the soldering portion 311, 321 so that the soldering portions 311, 321 are soldered on the PCB 5. Corresponding to the contact portions 312 of the upper terminals 31 and the contact portions 322 of the lower terminals 32, the electronic card 4 defines a plurality of contact pads 45 respectively on the upper surface 40 and the lower surface 41 in the mating side 42.

In an embodiment the card edge connector 1 further comprises two securing members 6 to ensure that the card edge connector 1 is securely fixed on the PCB 5. Each securing member 6 can be U-shaped, comprising a fixing slice 60 and a soldering slice 61 connecting with the fixing slice 60; and accordingly, the insulating body 2 defines a fixing slot 26 in each side on the bottom of the base 20. In other embodiments, the fixing slot 26 is provided on each side of the bottom of the assistant base 22. The fixing slice 60 of the securing member 6 is secured in the corresponding fixing slot 26, and the soldering slice 61 extends out from the insulating body 2 to be soldered on the PCB 5. Preferably, the securing members 6 are provided closely near the corresponding positioning post 24 to achieve excellent securing effect.

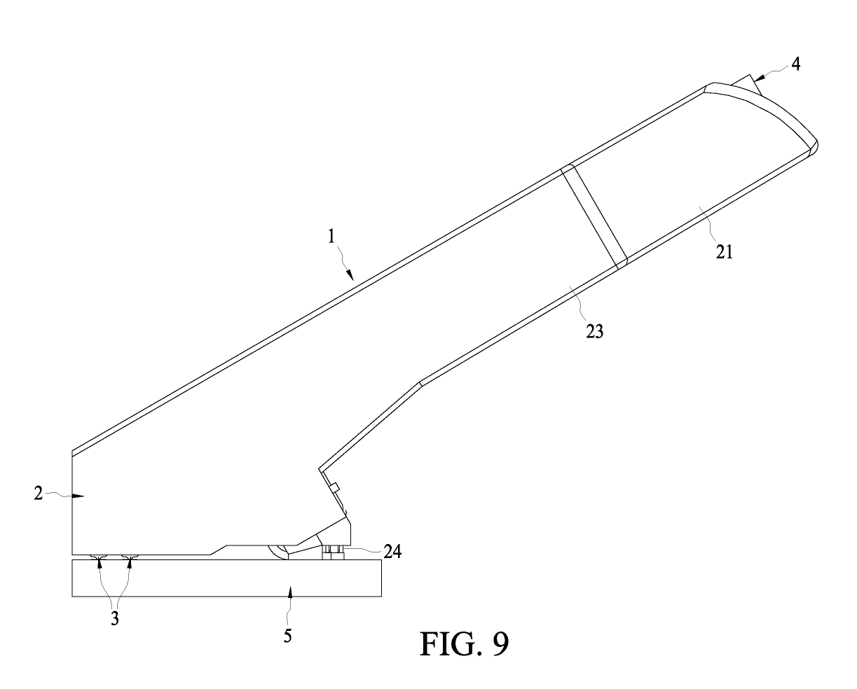

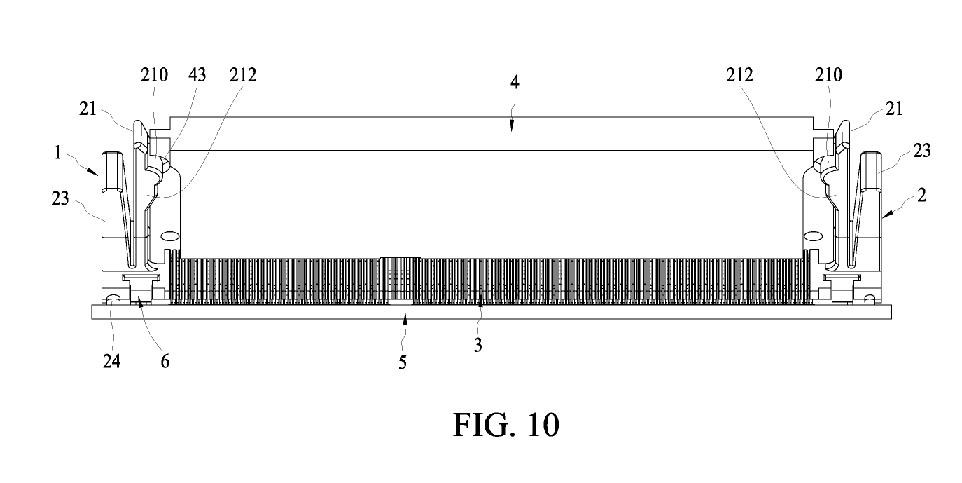

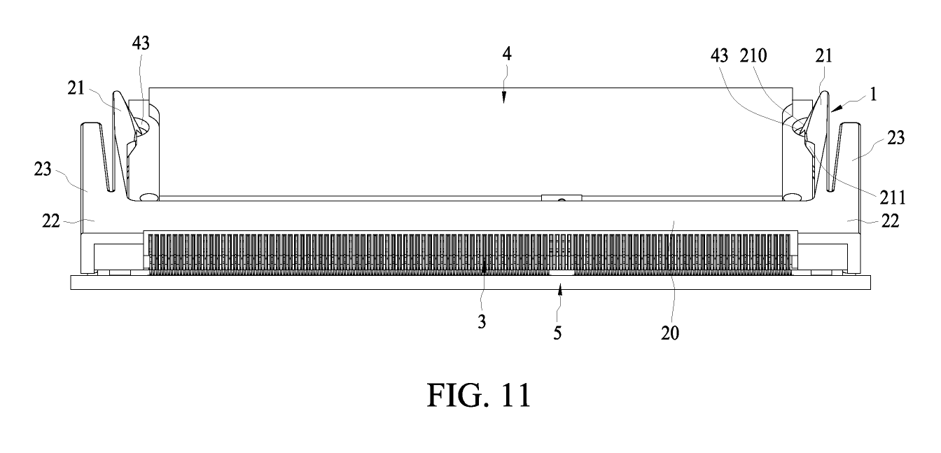

As shown in FIGS. 9 to 11, when the electronic card 4 is inserted into the card edge connector 1, it will be rotated to the locked position. The flexible arms 21 deforms when the electronic card 4 goes beyond the locking members 210 and the pressing member 211, and the stopping member 212 resists the lower surface 41 of the electronic card 4 when the electronic card 4 is rotated to the locked position to prevent the electronic card 4 from excessive movement. In the locked position, the locking members are respectively contained in the notches 43 provided in two sides of the electronic card 4, the pressing member 211 presses the upper surface 40 of the electronic card 4, and the stopping member 212 supports the lower surface 41 of the electronic card 4. Thus, the pressing member 211 on the top and the stopping member 212 on the bottom together hold the electronic card 4 in place during mechanical shock and vibration. Consequentially, the electrical connection between the electronic card 4 and the card edge connector 1 is stable.

Compared with the conventional card edge connector, the depicted design can provide locking members 210, pressing members 211, and stopping members 212 on the flexible arms 21. Thus, the length of the card edge connector 1 can be reduced.

The above-described embodiments are intended to be illustrative only. Numerous alternative embodiments may be devised by persons skilled in the art without departing from the scope of the following claims.

What is claimed is:

1. A card edge connector, comprising:
an insulating body, including:
a base defining a forward mating slot and a plurality of passageways communicating with the mating slot; and
two flexible arms respectively extending forward and upward from two ends of the base, including:
a locking member;
a pressing member near the locking member; and
a stopping member near the locking member and lower than the pressing member; and
a plurality of terminals correspondingly fixed in the plurality of passageways, each terminal including:
a fixing portion positioned in the base;
a soldering portion extending out of the base; and
a contact portion extending into the mating slot.

2. The card edge connector of claim 1, wherein the stopping member and the locking member connect with each other.

3. The card edge connector of claim 2, wherein the pressing member and the locking member connect with each other.

4. The card edge connector of claim 1, further comprising two positioning posts respectively extending from bottoms of the insulating body.

5. The card edge connector of claim 4, further comprising two securing members near the corresponding positioning posts, each securing member comprising a fixing slice and a soldering slice connected with the fixing slice, wherein the insulating body correspondingly defines a fixing slot for securing the securing member at the bottom of in each side, and the soldering slice extends out the insulating body.

6. The card edge connector of claim 5, wherein an assistant base further extends from each of the two sides of the base; and a resistance member further extends from the assistant base to be near outside of the corresponding flexible arm.

7. The card edge connector of claim 6, wherein when an electronic card is inserted into the card edge connector, the locking members are contained in notches in two sides of the electronic card, the pressing members press an upper surface of the electronic card, and the stopping members support a lower surface of the electronic card.

8. The card edge connector of claim 5, wherein the plurality of terminals comprise a group of upper terminals and a group of lower terminals, and accordingly, the plurality of passageways comprise a group of upper passageways for receiving the group of upper terminals and a group of lower passageways for receiving the group of lower terminals.
